(19) United States
(12) Patent Application Publication
(10) Pub. No.: US 2023/0196340 A1
(43) Pub. Date: Jun. 22, 2023

(54) METHODS AND SYSTEMS FOR FACILITATING COLLECTION OF ROAD USER CHARGES USING A DIGITAL CURRENCY BASED ON A DISTRIBUTED LEDGER TECHNOLOGY

(71) Applicant: Taylor William Paul Lochrane, Washington, DC (US)

(72) Inventor: Taylor William Paul Lochrane, Washington, DC (US)

(21) Appl. No.: 18/173,631

(22) Filed: Feb. 23, 2023

Related U.S. Application Data
(63) Continuation-in-part of application No. 17/829,748, filed on Jun. 1, 2022, now abandoned.
(60) Provisional application No. 63/209,109, filed on Jun. 10, 2021.

(51) Int. Cl. G06Q 20/36; G01C 21/34; G06Q 20/38; G06Q 20/40

(52) U.S. Cl. CPC G06Q 20/363; G01C 21/3461; G06Q 20/389; G06Q 20/4014

(57) ABSTRACT

A system and a method for facilitating the collecting of the Road Use Charges (RUC) using a digital currency based on a Distributed Ledger Technology (DLT) network is disclosed. The method includes processing the Road User data and Facility Owner data to generate user accounts on the DLT network, receiving Road User data from at least one Road User device, receiving position and distance data from at least one input device, receiving cost data from at least one Facility Owner device, analyzing data to generate a transaction(s) in the form of a policy and a smart contract, and adding the digital currency used for RUC (RUDC) corresponding to the payment alert to the digital wallet of the user, by a processing device on the DLT network. Further, method includes transferring the digital currency to Facility Owners digital wallets for RUC using the DLT network, using a storage device.

### FIELD OF THE INVENTION

The present invention relates generally to data processing. More specifically, the present invention includes methods and systems for facilitating the collection of a Road User Charges (RUC) using a digital currency based on a Distributed Ledger Technology (DLT).

### BACKGROUND OF THE INVENTION

The field of data processing is technologically important to several industries, business organizations and individuals.

Today in the US and around the world, a combination of federal, state, and local tax is collected to fund roads and highways through a petroleum-powered motor fuel tax, also known as the “gas tax.” As different alternative fuels emerge for vehicles (e.g., biodiesel, electricity, ethanol, hydrogen, natural gas, propane, etc.), no system is in place to collect motor fuel tax from vehicles not using a petroleum-powered energy source. Existing techniques for facilitating collecting road use fees are deficient with regard to several aspects. For instance, current technologies do not facilitate collecting motor fuel tax from vehicles not using a petroleum-powered energy source. Furthermore, current technologies do not collect road fees (or tax) using a digital currency normalized for vehicles using any energy source. Therefore, there is a need for improved methods and systems for facilitating the collecting of the Road User Charges (RUC) (also known as Vehicle Miles Traveled (VMT); Mileage-Based User Fee (MBUF); Road-User Charges; Road-use Charges, Road Usage Charge, Road Pricing, etc.) using a digital currency based on a Distributed Ledger Technology (DLT) network that may overcome one or more of the above-mentioned problems and limitations.

An objective of the present invention is to provide a method and system for facilitating the collection of a road use fee using a digital currency based on a distributed ledger technology.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

According to some embodiments, a method for facilitating the collection of a Road User Charge (RUC) using a digital currency based on a Distributed Ledger Technology (DLT) network is disclosed. The method comprises steps of receiving Road User digital data and Facility Owner digital data; processing the Road User digital data to generate at least one Road User account to store digital assets in a digital wallet, and the Facility Owner digital data to generate at least one Facility Owner account to store digital assets in a digital wallet; retrieving a digital currency to a digital wallet of the at least one Road User from at least one of a Trip Exchange platform and a fueling station platform digital wallet; analyzing Road User digital data from an RUC Application and generate a transaction of the digital currency in the form of at least one of a policy and a smart contract on the DLT network; transmitting the transaction of the digital currency in the form of the at least one of the policy and the smart contract to the at least one Road User device and the at least one Facility Owner device through the DLT network; adding the digital currency to a digital wallet of the Facility Owner account based on at least one of the policy and a smart contract and generate a transfer alert; and storing the at least one of the policy and the smart contract, a payment alert, and the transfer alert on the DLT network.

In some embodiments, the method includes steps of receiving position and distance data from at least one input device, receiving cost data from the at least one Facility Owner account; and retrieving Coin Manager data including cost data from an RUC database, Trip Manager data including digital map data, Trip Calculator data and Contract Manager data.

In some other embodiments, the method includes steps of installing the RUC Application on a vehicle platform or on a mobile device to manage the digital currency distribution, the RUC Application comprising a Coin Manager, Trip Manager, Trip Calculator, and a Contract Manager.

In yet some other embodiments, the Trip Manager may include a Graphical User Interface with a digital map.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a flowchart depicting an overall process for the method of the present invention.

FIG. 2 is a block diagram of a system for facilitating the collecting of the RUC using a digital currency, referred to as digital currency, based on a DLT network, in accordance with some embodiments.

FIG. 3 is a schematic of a system for facilitating collecting RUC by the exchange of fiat currency and other digital currency, on the Trip Exchange platform and transferring digital currency between Road Users and Facility Owners based on the DLT network, in accordance with some embodiments.

FIG. 4 is a flow diagram of a method for facilitating adding digital currency to the digital wallet at a fueling station platform and the Trip Exchange platform, in accordance with some embodiments.

FIG. 5 is a flow diagram of a method for facilitating generating transaction(s) of digital currency in the form of policies and smart contracts to the DLT network, for facilitating the collecting of the RUC, in accordance with some embodiments.

FIG. 6 is a flowchart depicting a subprocess for a method for receiving cost data, position and distance data etc. from associated devices, according to the present invention.

FIG. 7 is a flow diagram of a method for facilitating and generating digital currency based on Facility Owners for each roadway used during a Road User trip determined by segments for facilitating the collecting of the RUC using the DLT network, in accordance with some embodiments.

FIG. 8 is a flowchart depicting a subprocess for a method for receiving, adding and transmitting digital currency associated with a payment, according to the present invention.

FIG. 9 is a flow diagram of a method for facilitating generating transaction(s) of digital currency by segments of a trip based on Facility Owners for facilitating the collecting of the RUC using the DLT network, in accordance with some embodiments.

FIG. 10 is a flow diagram of a method for facilitating the collection of RUC at an Approved Designated Location (ADL), in accordance with some embodiments.

FIG. 11 is a schematic of a system for facilitating the collecting of the RUC using a digital currency, based on a DLT network, in accordance with some embodiments.

FIG. 12 is an illustration of an online platform consistent with various embodiments of the present disclosure.

FIG. 13 is a block diagram of a computing device for implementing the methods disclosed herein, in accordance with some embodiments.

### DETAILED DESCRIPTION OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods and systems for facilitating the collecting of the Road User Charges (RUC) using a digital currency (i.e. coins or tokens) using a Distributed Ledger Technology (DLT) network (includes, but not limited to, using a Directed Acyclic Graph, a Hyperledger, and Blockchain, etc.), embodiments of the present disclosure are not limited to use only in this context. Moreover, a DLT network 200 is comprised of individual entities referred to as nodes 210, which include software and hardware, connected to one another to create a network, and serve a point of secure data transfers using cryptographic methods. Each of the nodes create a local database to serves as their ledger, which is shared across other nodes to create a distributed ledger, with consensus methods to validate transactions in the network which may take the form of a policy and smart contracts. Moreover, the ledgers contain accounts which are managed by digital wallets, which require the proper secure keys to access and manage each account on the ledger. The DLT network 200 may leverage the combination of cloud 903, fog 904, and edge computing 905 to help distribute computing resources more efficiently and ensure that the distributed ledger network operates effectively and efficiently. Cloud computing 903 can be used to host the primary distributed ledger network nodes and provide the computing power needed for the consensus protocol and data validation process. Fog 904 computing can be used to provide additional computing resources in the local network, such as the network nodes deployed in a specific geographic region which can support the facility owners. The fog computing infrastructure can provide additional data processing capabilities to reduce latency and improve data processing performance. Edge computing 905 can be used to provide computing resources at the network edge, closer to the Road Users. This can be useful for processing transactions on the DLT in real-time. Edge computing can help to reduce the amount of data that needs to be transmitted back to the primary distributed ledger network nodes and can improve the overall system's efficiency.

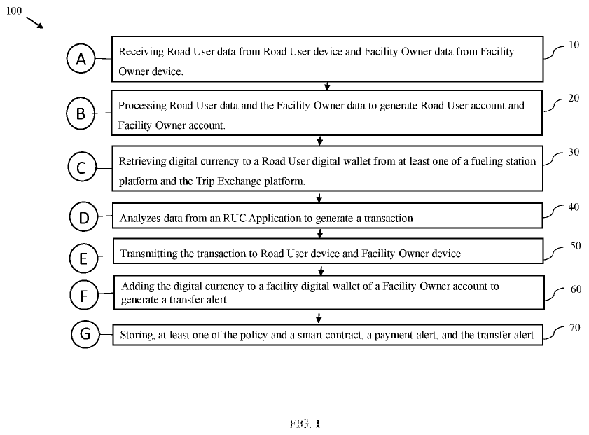

The following description is in reference to FIG. 1 through FIG. 13. As can be seen in FIG. 1 through FIG. 13, the present invention describes methods and systems for facilitating collecting a RUC using digital currency based on DLT.

As seen in FIG. 1 through FIG. 13 the system used to execute a method 100 of the present invention allows the present invention to function as a communication tool between multiple users. To accomplish that, an overall method of operation of the present invention comprises receiving, using a communication device, Road User data from at least one Road User device associated with at least one Road User and Facility Owner data from at least one Facility Owner device associated with at least one Facility Owner (step A at 10).

Preferably, the communication device may be any electronic device that can connect to the DLT network 200 through a wired and wireless communication module. The communication device, in some embodiments, may use minimal latency, low-power and various protocols. Examples of which include, but are not limited to Personal Area Network (PAN) Protocols (i.e. Bluetooth, Bluetooth Low Energy (BLE), NFC (Near Field Communication), RFID (Radio Frequency Identification), ANT/ANT+, Dedicated Short-Range Communications (DSRC), Light Fidelity (Li-Fi)); Local Area Network (LAN) Protocols (i.e. Wi-Fi); Wide Area Network (WAN) Protocols (i.e. Long-Range Wide Area Network (LoRaWAN), Signal for X (Sigfox), NB-IoT, Cellular Vehicle-to-Everything (C-V2X), Long Term Evolution (LTE), LTE-M, 4G, 5G, 6G, and next generation cellular and wireless, etc.); Mesh Network Protocols (i.e. Zigbee, Z-Wave, Thread, 6LoWPAN, etc.); Satellite Communications Protocols which include Geostationary Earth Orbit (GEO) protocols (i.e. HughesNet, Viasat, Inmarsat, Thuraya, etc.); Low Earth orbit (LEO) protocols (i.e. OneWeb, Telesat, Starlink, Iridium, Globalstar, etc.); Medium Earth orbit (MEO) protocols (i.e. GPS (Global Positioning System), Global Navigation Satellite System (GNSS), BeiDou, Galileo, GLONASS, IRNSS, etc.). The at least one Road User may include an individual, an institution, or an organization that may want to pay the RUC (or road tax) for driving a vehicle on a road. Further, the vehicle may be associated with a vehicle type such as passenger vehicles, trucks, buses, motorcycle, etc. For example, the at least one Road User may include a vehicle driver, and the at least one Road User device may include on-board vehicle device 908 such electronic control units (ECU), telematic systems, connected vehicle (CV) platforms, automated driver assistant systems (ADAS) platforms, automated driving system (ADS) platforms, cooperative automated driving system (CADS) platforms, and etc., and a mobile device such as laptop, a smartphone, a tablet, a personal computer, etc. Further, the at least one Facility Owner device may include wired and wireless communication modules connected to on-prem desktop computers, server computers and centralized and decentralized servers such cloud, fog and edge computing services Further, the Facility Owner devices may include Intelligent Transportation Systems (ITS) and Information Technology (IT) systems which may use Wireless Communication, ITS Roadside Equipment, Broadband Connectivity, etc. to connect to the DLT network 200.

The overall method of the present invention continues by processing, using a processing device, the Road User data to generate a Road User account and the Facility Owner data to generate a Facility Owner account (step B at 20). The Road User account and the Facility Owner account may include a digital wallet, a using cryptography to create a secure unique digital identifier such as but not limited to decentralized identity, etc.

Further, the overall method may comprise retrieving, using a storage device, digital currency to a Road User digital wallet from at least one of a fueling station platform and the Trip Exchange platform (step C at 30). According to the preferred embodiment, the Trip Exchange platform may be used to convert fiat currency to digital currency, or to create digital currency used for RUC (i.e., coins and tokens) etc. Preferably, the digital currency used for RUC (referred to as RUDC) is calculated based on RUC pricing from the RUC Rates database which could be centralized and decentralized using a DLT network 200. Preferably, the RUC Rates database is updated and maintained by Facility Owners, based on each road facility referred to as a segment, and host the cost data and may include different pricing models such as stable pricing, variable pricing, and dynamic pricing based on distance of travel, type of vehicle and other system level attributes. A digital wallet is an electronic device, software or online service that holds digital currency (i.e., coins and tokens) with values associated with fiat currency for transaction between individuals or business.

Furthermore, the system analyzes data from an RUC Application to generate a transaction in the form of at least one of a policy and a smart contract on a DLT network 200 using the processing device (step D at 40). In the preferred embodiment, data from the RUC Application comprises distance data, cost data and other input data based on a Trip Manager and a digital map. The digital map may include a geographical representation of a locality (such as city, province, country and, etc.). Further, the digital map may include details of the Facility Owner associated with the roadway. Thus, the policy and a smart contract may include different kinds of data, examples of which include, but are not limited to total distance traveled, a total cost of the segment and other data relevant for a trip. Accordingly, the total cost may be associated with digital currency used for RUC (RUDC) and the amount of the digital currency used for RUC (RUDC) may be equivalent to the total cost of the trip.

Continuing with the preferred embodiment, the overall method continues by transmitting the transaction in the form of the at least one policy and a smart contract to the at least one Road User device and the at least one Facility Owner device through the DLT network 200, using the communication device (step E at 50). The at least one Facility Owner may include an individual, an institution, and an organization that may be authorized to collect the RUC (or road tax). For example, the at least one Facility Owner may include a government roadway authority and other private operators. Further, the at least one Facility Owner device may include on-prem desktop computers, server computers and centralized and decentralized servers such cloud, fog and edge computing services. Furthermore, the cost data may include a cost for each vehicle type and distance based on different pricing models such as stable pricing, variable pricing, and dynamic pricing based on distance of travel, type of vehicle and other system level attributes for each roadway segment and associated with the Facility Owner.

Subsequently, the overall method may comprise adding the digital currency used for RUC (RUDC) to a facility digital wallet of a Facility Owner account based on the policy and a smart contract to generate a transfer alert for confirmation of completing transaction on a ledger, part of the DLT network 200, using the processing device (step F at 60). The Facility Owner account may be associated with the at least one Facility Owner, and the transfer alert may notify the at least one Facility Owner of receiving of the digital currency used for RUC (RUDC) corresponding to the policy and a smart contract on the distributed ledger network. Subsequently, the overall method comprises storing, at least one of the policy and a smart contract, a payment alert, and the transfer alert on the distributed ledger network using the storage device (step G at 70). The payment alert may include a consent and be fully automated from the at least one Road User to pay for the total cost. Further, the receiving of the payment alert may include receiving of funds (or fiat money, coins, tokens and, etc.) equivalent to the total cost. Furthermore, an amount of the digital currency used for RUC (RUDC) may be equivalent to the total cost of the trip, and the trip may include a plurality of segments. To that end, the total cost may include a cost for each segment of the plurality of segments, and each segment may include a roadway associated with a Facility Owner.

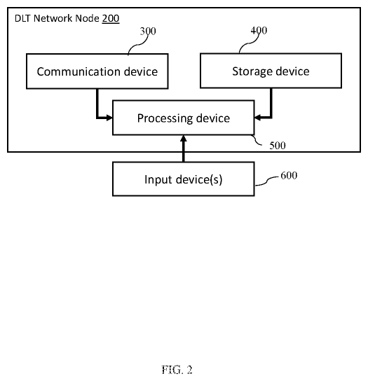

In reference to FIG. 2, a block diagram of a system for facilitating the collecting of the RUC using a digital currency, based on a DLT network 200, which comprises of DLT network node(s) 200 that may include communication device 300, storage device 400 and processing device 500 with data from input devices 600 in accordance with some embodiments is illustrated. Accordingly, the system may include the communication device 300 configured for receiving Road User data from at least one Road User device associated with the at least one Road User. Preferably, the communication device 300 may be any electronic device that can connect to the distributed ledger network through a wired and wireless communication module. Examples of communication protocols which include, but are not limited to Personal Area Network (PAN) Protocols (i.e. Bluetooth, Bluetooth Low Energy (BLE), NFC (Near Field Communication), RFID (Radio Frequency Identification), ANT/ANT+, Dedicated Short-Range Communications (DSRC), Light Fidelity (Li-Fi)); Local Area Network (LAN) Protocols (i.e. Wi-Fi); Wide Area Network (WAN) Protocols (i.e. Long-Range Wide Area Network (LoRaWAN), Signal for X (Sigfox), NB-IoT, Cellular Vehicle-to-Everything (C-V2X), Long Term Evolution (LTE), LTE-M, 5G, 6G, next generation cellular and wireless, etc.); Mesh Network Protocols (i.e. Zigbee, Z-Wave, Thread, 6LoWPAN, etc.); Satellite Communications Protocols which include Geostationary Earth Orbit (GEO) protocols (i.e. HughesNet, Viasat, Inmarsat, Thuraya, etc.); Low Earth orbit (LEO) protocols (i.e. OneWeb, Telesat, Starlink, Iridium, Globalstar, etc.); Medium Earth orbit (MEO) protocols (i.e. GPS (Global Positioning System), Global Navigation Satellite System (GNSS), BeiDou, Galileo, GLONASS, IRNSS, etc.). etc. Accordingly, the functionalities of the communication device (RUC communication device) 300 may comprise the following. The communication device 300 may be configured for receiving distance data from at least one input device. Preferably, the input device 600 may include a smart dashboard module both removable and integrated onboard a vehicle operating system, the vehicle that may be disposed on the vehicle of the at least one Road User.

In an embodiment, the input device 600 may include the at least one Road User device. Further, the communication device 300 may be configured for receiving cost data from at least one Facility Owner device and account/address associated with the at least one Facility Owner. Further, the communication device 300 may be configured for transmitting a transaction(s) in the form of the policy and a smart contract on the DLT network 200. Further, the communication device 300 may be configured for receiving a payment alert based on the policy and a smart contract from the at least one Road User device. Furthermore, the communication device 300 may be configured for transmitting a transfer alert to at least one of the at least one Road User device and the at least one Facility Owner device and account/address.

In the preferred embodiment, the processing device 500 of the system comprises a Coin Manager associated with a RUC Application (an exemplary embodiment of a software platform associated with the disclosed system). Accordingly, the functionalities of the processing device 500 may comprise the following. The processing device 500 is configured for processing the Road User data to generate the Road User account, and the Facility Owner data to generate Facility Owner account. Further, the processing device 500 may be configured for analyzing the position and distance data, the digital map data, RUC Rates, and the cost data based on the Trip Calculator to generate a transaction(s) in the form of the policy and a smart contract in a Contract Manager. Further, the processing device 500 may be configured for adding the digital currency corresponding to the payment alert to the digital wallet of the Road User. Further, the processing device 500 may be configured for adding the digital currency to a digital wallet of a Facility Owner account/address based on the policy and smart contract to generate the transfer alert. Further, the Facility Owner account may be associated with the at least Facility Owner. Further, the transfer alert may notify the at least one Facility Owner of receiving of the digital currency corresponding to the policy and smart contract, using the DLT network 200.

As seen in FIG. 2, the system may include a storage device 400 configured for retrieving the Coin Manager data including cost values from the RUC Rates database, the Trip Manager data including digital map data, and the Trip Calculator data.

Accordingly, the functionalities of the storage device 400 may comprise the following. The storage device 400 may be configured for retrieving the RUC Rates from RUC Rates database.

In the preferred embodiment, the Trip Calculator data may include a machine learning model configured for determining a total cost for the trip. Further, the digital map data may include a geographical representation of a locality (such as city, province, country and, etc.). Thus, the storage device 400 may be configured for storing the user data, the user account, the distance data, the cost data, the policy and smart contract, the payment alert, and the transfer alert on a DLT network 200.

In order to authenticate the various transactions, the system may in some embodiments, comprises a verification process. Thus, according to the preferred embodiment, the method may further comprises a step of transmitting verification of the identity of the at least one Facility Owner device, using the communication device. Further, the method may comprises receiving, verification of identity and transaction in the form of the payment alert based on the policy and smart contract from the at least one Facility Owner device, using the communication device.

A more detailed description of the Trip Exchange platform 800 follows. To accomplish step F and step G of the overall method 100, the system requires creating the Road User account 700 and the Facility Owner account 750 on the Trip Exchange platform 800.

Accordingly, the at least one Road User may exchange currency for digital currency in the Trip Exchange platform. In other words, the Trip Exchange platform may be used to convert fiat currency to digital currency, and to create digital currency for RUC (i.e., coins and tokens) etc. Thus, according to the preferred method, the digital currency from the Trip Exchange platform may be transferred to a digital wallet of the at least one Road User account, as well as digital currency from the digital wallet of the Facility Owner account may be transferred to the Trip Exchange platform. Further, digital currency from the Trip Exchange platform may be exchanged for fiat currency and other digital currency by the Facility Owner. Thus, the digital currency used for RUC (RUDC) created in the Trip Exchange platform are stored in digital wallets of the at least one Road User account and the at least one Facility Owner account.

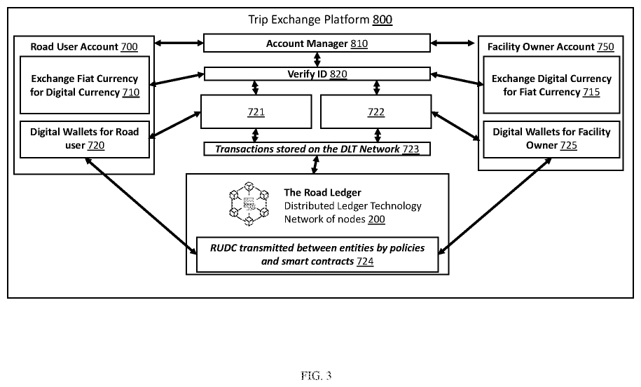

FIG. 3 is a schematic of a system for facilitating collecting RUC by the exchange of fiat currency and other digital currency, and transferring digital currency between Road Users and Facility Owners based on a DLT network 200, in accordance with some embodiments.

As seen in FIG. 3, a Road User may exchange fiat currency (i.e., USD, Euro, etc.) and other digital currency (i.e. Bitcoin, Ethereum, IOTA, etc.) for digital currency used for RUC, as well as the Facility Owner may exchange digital currency used for RUC (RUDC) for fiat currency and other digital currency at 710, in the Trip Exchange platform account manager 810. The digital currency may be used as the asset to be transacted on a DLT network 200. Further, the Road Users and the Facility Owners (or the Facility Owner) may create accounts 700, 750 on the Trip Exchange platform 800. Further, the Road Users and Facility Owners have digital wallets 720, 725 with accounts/address to hold digital currency (i.e., coins and tokens). The Road Users and Facility Owners may have a single account for digital currency used for RUC (RUDC) and/or Multi Accounts for other coins/tokens.

Preferably, the Road User and Facility Owners may be verified using a secure unique decentralized identity technology 820. Further, the digital wallets 720, 725 may store the digital currency created in the Trip Exchange platform 800. Further, at 721, the digital currency may be transferred from the Trip Exchange platform 800 to a digital wallet of the Road User 720.

Further, at 722, the digital currency may be exchanged using a DLT network 200 (includes, but not limited to, using a Directed Acyclic Graph, a Hyperledger, and Blockchain, etc.). Further, at 723, the DLT network 200 may store, manage and maintain the transaction(s) for RUC (e.g., Vehicle Miles Traveled (VMT); Mileage-Based User Fee (MBUF), Road-use Charges, Road Usage Charge, Road Pricing, etc.). Further, at 724, the digital currency may be transferred from Road User digital wallets 720, by a policy and smart contract (which could be a hybrid smart contract), using the DLT network 200, to the respective Facility Owner digital wallets 725. Further, the Facility Owner may transfer digital currency from a digital wallet of the Facility Owner 725 to the Trip Exchange platform 800.

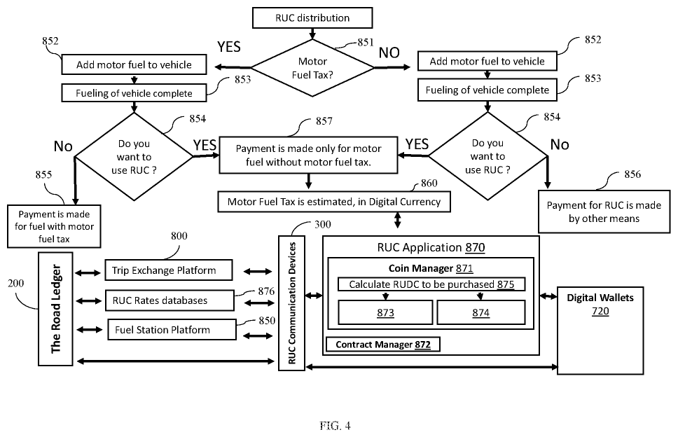

In reference to FIG. 4, a flow diagram of the method for facilitating adding digital currency to the Road User digital wallet at a fueling station platform 850, in accordance with some embodiments is illustrated.

The fuel stations may include both commercial vendors (i.e., Gas Stations, Charging Stations, and etc.) and private on-grid and off-grid fuel stations (i.e., personal solar panel charging, home electrical charging and, etc.).

Accordingly, the method using the fueling station platform 850 commences when a Road User vehicle arrives at a fueling station platform to add motor fuel (i.e., petroleum, biodiesel, electricity, ethanol, hydrogen, natural gas, propane etc.).

Further, at the fueling station, a Road User vehicle owner associated with petroleum-powered vehicles (any vehicle) may, at 851, choose to pay motor fuel tax or participate in RUC at the fuel station platform 850. Road Users that participate in RUC will not pay the motor tax and use digital currency to pay for Road Use. After determination of whether the Road user is paying for motor fuel tax at 851, Road User adds motor fuel to vehicle at 852 and complete Fueling of vehicle at 853.

The method may be configured to determine whether the Road user wants to use RUC (unless required by law) at 854. At 855, Payment can be made for fuel with motor fuel tax or Payment for RUC can be made by other means (approved by proper authorizes) at 856. If using RUC, payment can be made only for motor fuel without motor fuel tax at 857.

Further, at 860, the RUC Application (or software platform 870) using Coin Manager 871 associated with the disclosed system may estimate the number of digital currency required based current balance of digital currency in Road User digital wallet 720 and the estimated range of the motor fuel added to the vehicle and historical data from past trips.

Further, the RUC Application 870 using Coin Manager 871 may calculate RUDC to be purchased at 875 and Coin Manager 871 and Contract Manager 872, at 873, can also directly purchase digital currency from the fuel station platform 850, using a DLT network 200, after fuel has been added to the vehicle included in final payment.

Further, fueling stations that cannot provide digital currency used for RUC (RUDC) and are private on-grid or off-grid stations, the Coin Manager 871 and Contract Manager 872 may connect to the Trip Exchange platform account manager 810 wired and wirelessly connect to purchase additional digital currency (i.e., coins and tokens) at 874. Further, digital currency used for RUC (RUDC) may be purchased in exchange for fiat currency and other digital currency.

Further, the digital currency used for RUC (RUDC) may be transferred to the digital wallet 720 of the Road User after the identity is verified. All transactions are added to the DLT network 200.

Thus, according to the present invention, the functionality of the Coin Manager 871 comprises calculating number of digital currency used for RUC (RUDC) required when adding motor fuel, connecting to the Trip Exchange platform 800 to purchase digital currency and accept pre-paid coins or tokens used for RUC (RUDC) from fuel station platform 850 with the Contract Manager 872, and connecting to an RUC Rates database 876 that maintains Facility Owner account information and the cost for each road facility may include different pricing models such as stable pricing, variable pricing, and dynamic pricing based on distance of travel, vehicle type and other variables which is set by the Facility Owner.

A more detailed description of the RUC Application 870 with the help of a flow diagram follows.

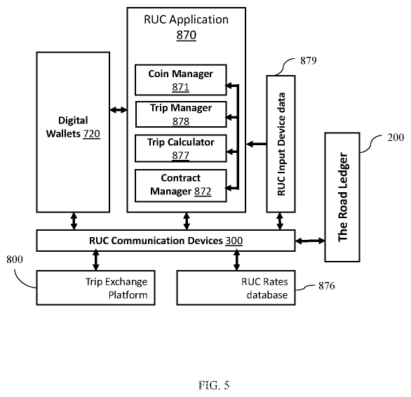

FIG. 5 is a flow diagram of a method for facilitating generating transaction(s) of digital currency in the form of policies and smart contracts to the DLT network 200 for facilitating the collecting of the RUC, in accordance with some embodiments.

Accordingly, the RUC Application 870 may be hosted onboard a vehicle or on a mobile device. Further, the Coin Manager 871 associated with the RUC Application 870 may enable the estimation of tokens needed when fuel is added. Further, the Coin Manager 871 may connect to the Trip Exchange Platform 800 to process a transfer fiat currency for digital currency. Further, the RUC Rates database 876 associated with the RUC Application 870 may host all the costs for each roadway. Further, the RUC Rates database 876, stored on the network, may provide the cost for each vehicle type for each roadway. The cost of each roadway may be managed by the Facility Owner and posted here to support the Road Use Calculator for processing the cost of the roadway.

Further, the Coin Manager 871 associated with the RUC Application 870 may capture the routes taken on a trip and break them into segments. A segment is part of a trip where the Facility Owner remains constant during the trip.

The Coin Manager 871 may collect the distance traveled to be used in a policy and smart contract. Further, the Trip Calculator 877 prepares the total cost for the policy and smart contracts. Further, the Contract Manager 872 associated with the RUC Application 870 may prepare the policy and smart contracts for each segment of the trip and use the digital currency to post on the DLT network 200.

To accomplish the above-mentioned functionalities, the RUC Application 870 is installed on-board on a vehicle platform 908 or installed on a mobile device to manage digital currency distribution. The RUC application 870 further comprises a Coin Manager 871, a Trip Manager 878, a Trip Calculator 877, and a Contract Manager 872. As previously mentioned, the RUC Application 870 associated with the disclosed system may be installed on-board a vehicle platform 908 or installed on a mobile device to manage RUC distribution. Further, the RUC Application 870 may include a Graphical User Interface for the Road User to interface with application.

Accordingly, in some embodiments, the present invention may include a Trip Manager 878 having a Graphical User Interface with a digital map includes steps of: determining a vehicle location and a current Facility Owner; determining whether a trip is planned; determining at least one segment; recording a distance data for one or more segments; displaying the at least one segment on the digital map; transferring the distance data to the Trip Calculator.

Further, the RUC Application 870 uses the Coin Manager 871 and the Trip Calculator 877 to estimate number of digital currency required when adding motor fuel. Further, the RUC Application 870 uses the Coin Manager 871 to connect to Trip Exchange platform 800 to purchase digital currency or accept pre-paid coins or tokens used for RUC (RUDC) from fuel station platform 850, using a DLT network 200, and transfer digital currency to the digital wallet 720 of the Road User.

Further, the Coin Manager 871 may connect to a RUC Rates database 876 that maintains Facility Owner account/address information and the rates/prices for each road facility which may include different pricing models such as stable pricing, variable pricing, and dynamic pricing based on distance of travel, type of vehicle and other system level attributes that may be set by the Facility Owner and provides information to the Trip Manager.

Further, the Trip Manager 878 may determine location of vehicle, identify the Facility Owners which the vehicle is operating on using digital maps or other means, maintain trip information based on segments, collect distance of travel data from available RUC Input Device data (i.e. Global Positioning System (GPS) data, Inertial Measurement Unit (IMU) data, odometer data, digital map data, on-board unit data, telematics data, cellular data, satellite data, OBDII device data, and etc.).

In the preferred embodiment, the RUC Application 870 uses the Trip Calculator 877 to manage the cost for using each facility based on data from Trip Manager 878 and the Coin Manager 871. The Trip Calculator 877 prepares the transaction(s) to be provided to the Contract Manager 872 at the completion of a segment and trip.

Further, the RUC Application 870 uses the Contract Manager 871 to execute transaction(s) of digital currency, that may be stored in the Road User digital wallet 872, from the Trip Calculator 877 for each Segment and trip on the DLT network 200. The Contract Manager 872 connects using the communication device (i.e., Personal Area Network (PAN) Protocols; Local Area Network (LAN) Protocols; Wide Area Network (WAN) Protocols; Mesh Network Protocols; Satellite Communications Protocols which include Geostationary Earth Orbit (GEO) protocol, Low Earth orbit (LEO) protocols; Medium Earth orbit (MEO) protocols. and, etc.) to connect to the DLT network 200. The Contract Manager 872 wire and wirelessly.

connects to the DLT network 200, through the cloud computing, fog computing or edge computing to process transaction(s) on the distributed network. The DLT network 200, supports online transaction(s) and off-line peer-to-peer transaction(s) at the edge computing level along the roadside.

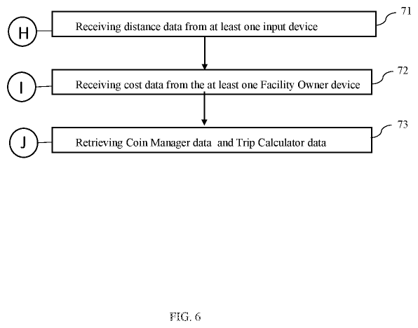

In reference to FIG. 6, a sub-process of the overall method is depicted, the sub-process comprising the step of receiving distance data from at least one input device, using the communication device (step H at 71). Preferably, the distance data may be associated with a trip that may be characterized by a trip distance, trip route, etc. As seen in FIG. 6, after step C of the overall method, the sub-process comprises receiving cost data from the at least one Facility Owner device associated with the at least one Facility Owner, using the communication device (step I at 72). Preferably, the cost data may include a cost for each vehicle type for each roadway associated with the Facility Owner. Furthermore, the sub-process continues by retrieving Coin Manager data (including cost values from the RUC Rates database, and digital map data, etc.), and Trip Calculator data, using the storage device (step J at 73).

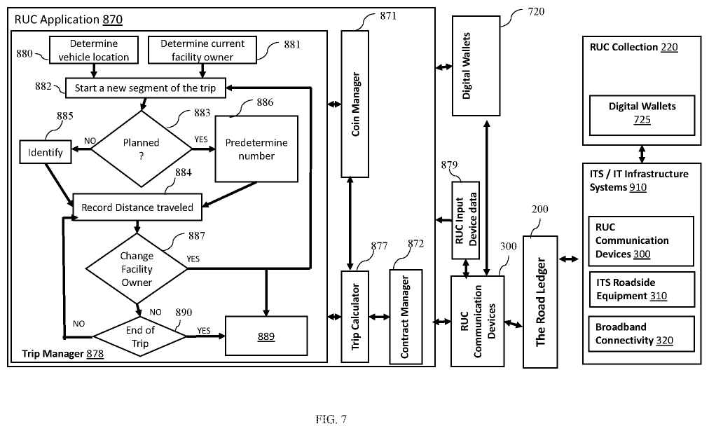

In reference to FIG. 7, a flow diagram of a method for facilitating and generating digital currency based on Facility Owners during a Road User trip determined by segments for facilitating the collecting of the RUC, in accordance with some embodiments is illustrated.

Accordingly, a trip may be defined as the start and end of a specific route taken on the roadway network. Further, the disclosed system may be configured for determining a start location of the vehicle and the current Facility Owner to start a first segment. The vehicle may follow a route or monitor nearby Facility Owners for no pre-planned driving. The trip may be broken into one or more segment(s). A segment is where the Facility Owner remains constant during the trip. As the Facility Owner changes, a new segment is started.

In some embodiments, the change of the Facility Owner from one segment to another can be detected by using sensors or cameras installed in a vehicle, communication device, input device or any device known in the art that can be connected to the present invention.

Accordingly, the method and system of present invention may include steps of determining, by the computing device via the processing device 500, a first Facility Owner segment location and a second Facility Owner segment location. Further, if the first Facility Owner segment location and the second Facility Owner segment location is different, at least one segment can be displayed on the digital map 888 showing trip progress of the Road user.

In some embodiments, the first Facility Owner segment location (which can be a point located at the rear side of the Road user/vehicle) and the second Facility Owner segment location (which can be a point located at the front side of the Road user/vehicle) can be detected at a predetermined distance from the Road user location so that the change of the Facility Owner can be properly detected when the two points (first and second Facility Owner segment locations) indicate different Facility Owner.

For example, the method may include a step of determining, by the computing device via the processing device 500, a first Facility Owner segment location and a second Facility Owner segment location. Further, in response to determining the first Facility Owner segment location and the second Facility Owner segment location, if the first Facility Owner segment location and the second Facility Owner segment location is different, at least one segment can be displayed on the digital map 888.

The Trip Manager 878 may also collect the distance traveled to be used in a policy and smart contract by the Contract Manager 872. Once a segment is completed then the Contract Manager 872 collects required data from Coin Manager 871, Trip Manager 878, and Trip Calculator 877, to meet the conditions of a policy and smart contract on the DLT network 200, for Road Use of the vehicle.

More specifically, Trip Manager 878 (described in FIG. 7) associated with the RUC Application 870 may capture the routes taken on a trip and break them into segments. A segment is part of a trip where the Facility Owner remains constant during the trip. The Trip Manager 878 may collect the distance traveled to be used in a policy and smart contract by the Contract Manager 872. Thus, according to the preferred embodiment, the method comprises, determining the location of a vehicle and current Facility Owner using data from RUC input device data by the Trip Manager 878 at 880, 881.

At 882, the method then starts a new segment by determining the start of a segment by the Trip Manager 878. At 883, the method further includes determining whether the trip is planned or not planned with pre-selected route by the Trip Manager 878, and recording distance data for each segment of a trip by the Trip Manager 878 at 884. If the route is planned, the method may use predetermine number of segments for each facility owner for the trip at 886 or if the route is not planned, the method may identify all surrounding facility owners for the trip and monitor next segment at 885.

If there is a change of Facility owner detected, the method may start a new segment of the trip at 887. At the end of the trip 890 and when the Facility owner is changed, the method may prepare the segment(s) for the trip with distance data at 889.

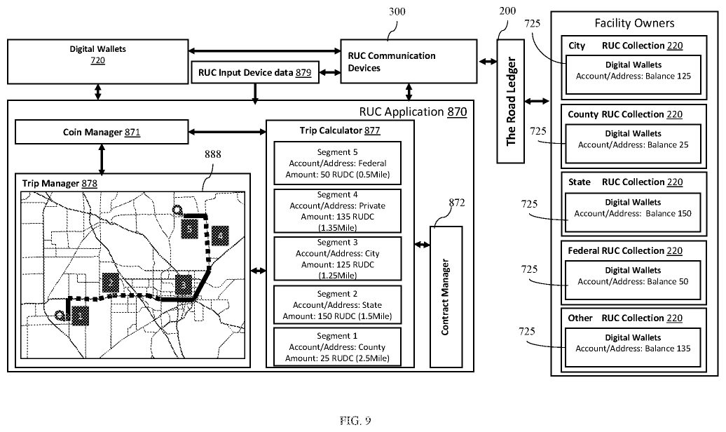

In the preferred embodiment, the Trip Calculator 877 (described in FIG. 9) prepares the total cost and processes the cost of each roadway segments to later be used by the Contract Manager 872. Accordingly, the method of the present invention comprises managing the cost for using each facility based on data from the Coin Manager 871 through the RUC Rates database 876 wherein the Trip Calculator 877 uses input from the Trip Manger 878 to prepare all the data needed to support transactions for the Contract Manager 872 for each segment owned by a different Facility Owner. Further, the Trip Calculator 877 gathers Facility Owner account/address information form the Coin Manager 871 through the RUC Rates database 876 for each segment provided by the Trip Manager 878 and determines the number of digital currency to be provided to the Facility Owners based RUC Rates for each transaction.

Continuing with the preferred embodiment, the Contract Manager 872 associated with the RUC Application 870 may prepare the policy and smart contract and required data to meet conditions for each segment of the trip and use the digital currency for payment of Road Use to post on the DLT network 200. To that end, the method comprises executing transaction of Digital currency, which are stored in the Road User digital wallet 720, from the Trip Calculator 877 for each segment of a trip on DLT network 200, using the Contract Manager 872. The method further comprises logging all transactions from the at least one Road User using the DLT network 200, for auditing purposes.

Further, the Trip Manager 878 may record the distance data for each segment(s), where the Facility Owner is constant, along the trip until the completion of the trip, and transfer this data to the Trip Calculator 877. Further, the Contract Manager 872 may execute transaction(s) of digital currency, that may be stored in the Road User digital wallet 720, from the Trip Calculator 877 for each segment and trip on the DLT network 200. Further, the Contract Manager 872 connects using a communication device 300 (i.e., Personal Area Network (PAN) Protocols; Local Area Network (LAN) Protocols; Wide Area Network (WAN) Protocols; Mesh Network Protocols; Satellite Communications Protocols which include Geostationary Earth Orbit (GEO) protocol, Low Earth orbit (LEO) protocols; Medium Earth orbit (MEO) protocols and etc.) to the DLT network 200. Further, the Facility Owner may connect to the DLT network 200, through ITS/IT infrastructure systems (which may include wired and wireless communication devices, ITS roadside equipment, broadband connectivity and etc.) to connect Facility Owner digital wallet. Further, the Facility Owner receives the digital currency directly to a digital wallet from the Road User for each segment and trip using the DLT network 200.

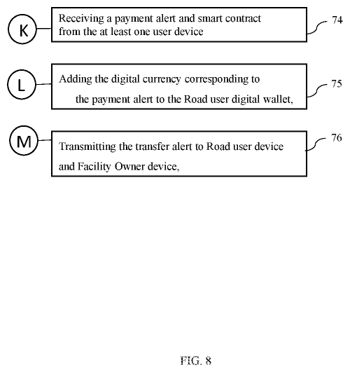

In reference to FIG. 8, a sub-process of the overall method is depicted, wherein the sub-process includes, receiving a payment alert based on the policy and smart contract from the at least one user device, using the communication device (step K at 74). The payment alert may include a consent from the at least one user to pay for the total cost. Subsequently, the sub-process continues by adding the digital currency corresponding to the payment alert to the digital wallet of the user, using the processing device 500 (step L at 75). The receiving of the payment alert may include receiving of funds (or money, coins, tokens, digital currency, etc.) equivalent to the total cost. The sub-process further comprises a step of transmitting the transfer alert to at least one of the at least one user device and the at least one Facility Owner device, using the communication device (step M at 76). The transfer alert may notify the at least one Facility Owner of receiving of the digital currency corresponding to the policy and smart contract.

In reference to FIG. 9, is a flow diagram of a method for facilitating generating transaction(s) of digital currency by segments of a trip based on Facility Owners for facilitating the collecting of the RUC, in accordance with some embodiments is illustrated. Accordingly, each segment may be transmitted to the appropriate Facility Owner through a policy and smart contract on the DLT network 200. Further, each policy and smart contract may include the digital currency attached as payment of road use on the facility. According to the preferred embodiment, road owners and operators may be separated into different categories (i.e., Federal, State, County, City, Private, other and etc.) for RUC collection 220. Further, each road owner may have their account/unique ID and will act as a Node in the DLT network 200 (includes, but not limited to, using a Directed Acyclic Graph, a Hyperledger, and Blockchain, etc.). Each of the facilities of the road owner may be linked to an account on the DLT network 200. Further, the facility owners can exchange the digital currency for fiat currency using the Trip Exchange platform account manager 810. Further, digital currency distribution is based on the vehicle route and which facilities are used during the trip. Further, a digital map 888 may be used with a control layer that may be configured and used to link facilities to accounts/address on the DLT network 200 with the Facility Owner.

In one embodiment, the trip manager 878 may include the digital map 888 to display one or more segments.

Further, each entity/vehicle may use the distance traveled on each road facility as a means of distributing digital currency via a policy and smart contract. Further, the policy and smart contract may be generated to transact digital currency to the appropriate Facility Owner. Further, each policy and smart contract may execute after exiting a road facility (i.e., when road Facility Owners change) or at the end of a trip. This may be defined by the DLT network 200, that will manage the digital currency transaction(s). If there is no connectivity, the vehicle or mobile device may store the transaction(s) on-board until connectivity is available to make the transaction(s).

Further, the Coin Manager 871 may break the trip into different segments based on the Facility Owner (i.e., Federal, State, County, City, Private, etc.). Further, the Coin Manager 871 may be configured for receiving the RUC Rates, that define the cost for each road facility may include different pricing models such as stable pricing, variable pricing, and dynamic pricing based on distance of travel and vehicle type. Further, the Trip Calculator 877 may prepare all the transaction(s) for the Contract Manager 872 for each segment owned by a different Facility Owner.

Further, the Trip Calculator 877 gathers account/address information from the Coin Manager 871 through the RUC Rates database for each segment. Further, the Trip Calculator 877 determines the number of digital currency based RUC Rates (i.e., distance and vehicle type rates/cost) for each transaction(s).

Further, the Contract Manager 872 may execute transaction(s) of digital currency, which are stored in the digital wallet of the Road User and for each Segment and trip provided by Trip Calculator, on the DLT network 200. Further, the Contract Manager 872 may log all transaction(s) form the Road User using on-board storage device and the DLT network 200 for auditing purposes. Further, the Facility Owner receives the digital currency directly to the digital wallet of the Facility Owner 725 from the Road User for each segment and or trip using the DLT network 200. Further, the Facility Owner may transfer digital currency from their digital wallet 725 to the Trip Exchange platform 800. Further, the Facility Owner may exchange the digital currency for fiat currency or other digital currency in the Trip Exchange platform 800.

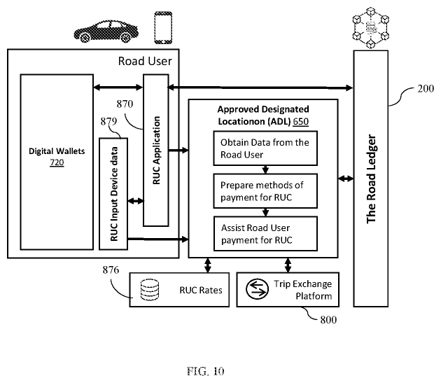

In reference to FIG. 10, is a flow diagram of a method for facilitating RUC at an Approved Designated Location (ADL) 650, in accordance with some embodiments is illustrated. Accordingly, Road Users that do not have a communications device 300 can transact their RUC stored on the RUC Application 870 and report their mileage directly from their RUC input devices 600, for any vehicle, at an Approved Designated Location (ADL) (i.e., Department of Motor Vehicles (DMV)) 650, Inspection center, private organization, etc.).

Further, the Road Users may report to the ADL 650 based on any required frequency (i.e., monthly, bi-annually, annually, etc.). Further, the RUC pricing model based on reporting frequency (monthly, bi-annually, annually, etc.) may be provided by the RUC Rates database 876 and may include a distribution model for RUC to the designated Facility Owner accounts (i.e., federal, state, city, county, other, etc.) 750.

Further, the Road Users with a RUC Application 870 may provide their data, for a specific reporting period, to the ADL 650 used to transact RUC. Further, the ADL 650 may create a policy and smart contract for the Road User. Further, the Road User will link their digital wallet 720 to the policy and smart contract created by the ADL 650 to transact digital currency for RUC to be stored on the DLT network 200.

Further, the Road Users without a RUC Application 870 may report their total road use distance (i.e., miles, kilometers, etc.) from onboard device (i.e. OBU, odometer, OBDII port device, onboard software application, etc.), for a specific reporting period, to the ADL 650 used to transact RUC. Further, the ADL 650 may create a policy and smart contract for the Road User.

Further, the Road User will link their digital wallet 720 to the policy and smart contract created by the ADL 650 to transact digital currency for RUC to be stored on the DLT network 200. Further, the ADL 650 may connect to the Trip Exchange platform 800, for Road Users that do not have a digital wallet 720, to exchange any fiat and other digital currency for digital currency to be used in the policy and smart contract to transact digital currency for RUC to be stored on the DLT network 200.

Further, the Road Users without a RUC Application 870 may pay for their road use in the form of a yearly payment, or other options managed by the roadway authority, to the ADL 650. Further, the ADL 650 may accept fiat currency for payment for Road Use. Further, the ADL 650 may connect to the Trip Exchange platform 800, for Road Users that do not have a digital wallet 720, to exchange any fiat and other digital currency for digital currency to be used in the policy and smart contract to transact digital currency for RUC payment for the Road User to be stored on the DLT network 200.

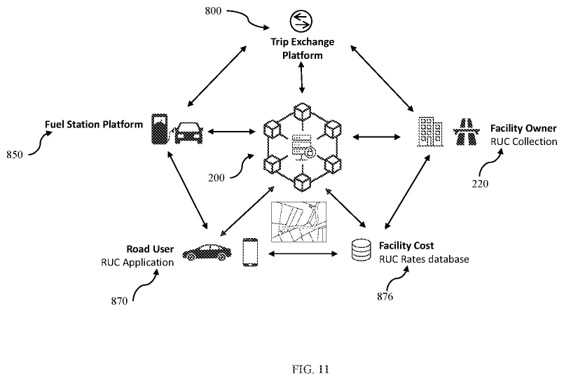

In reference to FIG. 11, an overall representation of the system of the present invention is depicted. In other words, FIG. 11 is a schematic of a system for facilitating the collecting of the RUC using a digital currency based on a DLT network 200, in accordance with some embodiments.

Accordingly, the system may be associated with the DLT network 200. Further, the fueling station platform 850 may be communicatively coupled to the system (or the DLT network 200). Further, the fueling station platform 850 may facilitate digital currency distribution to a digital wallet of a Road User (or a driver). Further, the Road User may use a RUC Application software 870 on-board a vehicle 908 or mobile device. Further, the RUC Application 870 may facilitate executing RUC policies and smart contracts based on trip segments. Further, the system may include an RUC Rates database 876 configured for storing the road facility cost which may include different pricing models such as stable pricing, variable pricing, and dynamic pricing based on distance of travel and vehicle type set by the Facility Owner. Further, the Facility Owners (e.g., IOOs) may collect the digital currency (RUC collection 220) from policies and smart contracts executed on the DLT network 200.

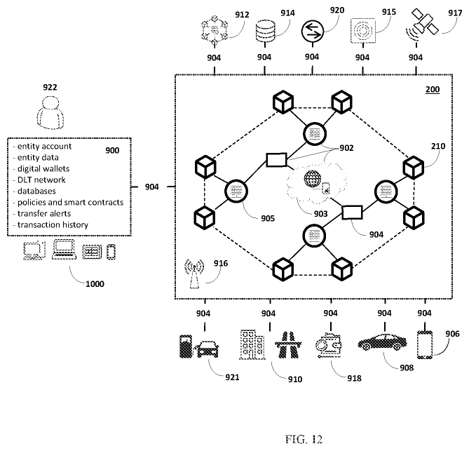

FIG. 12 is an illustration of an online platform 900 consistent with various embodiments of the present disclosure. By way of non-limiting example, the online platform 900 for facilitating the collecting of the RUC using a digital currency based on a DLT network 200 may be hosted on a centralized and decentralized server 902, such as, for example, an on-prem, cloud 903, fog 904 or edge computing 905 (i.e., MEC) service. The centralized and decentralized server 902 may communicate with other network entities, such as, for example, a mobile device 906 (such as a smartphone, a laptop, a tablet computer, etc.), an on-board vehicle device 908 (such as electronic control units, connected vehicle platforms, automated driver assistance system platforms, automated driving system platforms, telematic systems, OBDII devises, and etc.), roadway facility owners infrastructure devices/systems 910 (such as Intelligent Transportation Systems (ITS) and Information Technology (IT) systems including but not limited to RUC Communication 300, ITS Roadside Equipment 310, Broadband Connectivity 320, owned and operated by city, county, state, federal, private/other, etc.), other electronic devices 912 (such as distributed desktop computers, server computers, edge computers that form a networks, etc.), databases 914, sensors 915, wireless communication protocols 916, satellite communication protocols 917, digital wallets 918 (including but not limited to software and hardware wallets), digital currency exchange platforms 920, fueling station platforms 921, (online network) 904, such as, but not limited to, the Internet. Further, users of the online platform 900 may include relevant parties such as, but not limited to, end-users, service providers, and administrators. Accordingly, in some instances, electronic devices operated by one or more relevant parties may be in communication with the online platform 900. A user 922, such as the one or more relevant parties, may access the online platform 900 through a web-based software application or browser (including but not limited to web 2.0 and web 3.0). The web-based software application may be embodied as, for example, but not be limited to, a website, a web application, a desktop application, a mobile application, on-board vehicle application, roadside application, compatible with a computing device 1000.

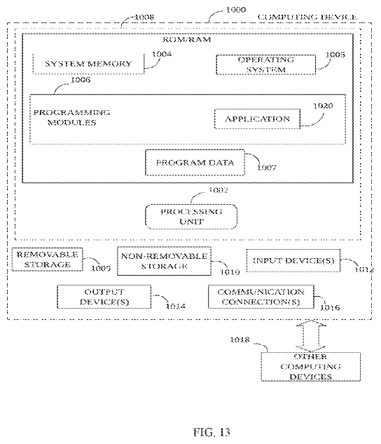

With reference to FIG. 13, a system consistent with an embodiment of the disclosure may include a computing device or cloud, fog or edge service, such as computing device 1000. In a basic configuration, computing device 1000 may include at least one processing unit 1002 and a system memory 1004. Depending on the configuration and type of computing device, system memory 1004 may comprise, but is not limited to, volatile (e.g., random-access memory (RAM)), non-volatile (e.g., read-only memory (ROM)), flash memory, or any combination. System memory 1004 may include operating system 1005, one or more programming modules 1006, and may include a program data 1007. Operating system 1005, for example, may be suitable for controlling computing device 1000's operation. In one embodiment, programming modules 1006 may include image-processing module, machine learning module and image classifying module. Furthermore, embodiments of the disclosure may be practiced in conjunction with a graphics library, other operating systems, or any other application program and is not limited to any particular application or system. This basic configuration is illustrated by those components within a dashed line 1008.

Computing device 1000 may have additional features or functionality. For example, computing device 1000 may also include additional data storage devices (removable and non-removable) such as, for example, magnetic disks, optical disks, or tape. Such additional storage is illustrated in FIG. 13 by a removable storage 1009 and a non-removable storage 1010. Computer storage media may include volatile and nonvolatile, removable and non-removable media implemented in any method or technology for storage of information, such as computer-readable instructions, data structures, program modules, or other data. System memory 1004, removable storage 1009, and non-removable storage 1010 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information, and which can be accessed by computing device 1000. Any such computer storage media may be part of device 1000. Computing device 1000 may also have input device(s) 1012 such as a keyboard, a mouse, a pen, a sound input device, a touch input device, a location sensor, a camera, a biometric sensor, etc. Output device(s) 1014 such as a display, speakers, a printer, etc. may also be included. The aforementioned devices are examples and others may be used.

Computing device 1000 may also contain a communication connection 1016 that may allow device 1000 to communicate with other computing devices 1018, such as over a network in a distributed computing environment, for example, an intranet or the Internet. Communication connection 1016 is one example of communication media. Communication media may typically be embodied by computer-readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer-readable media as used herein may include both storage media and communication media.

As stated above, a number of program modules and data files may be stored in system memory 1004, including operating system 1005. While executing on processing unit 1002, programming modules 1006 (e.g., application 1020 such as a media player) may perform processes including, for example, one or more stages of methods, algorithms, systems, applications, servers, databases as described above. The aforementioned process is an example, and processing unit 1002 may perform other processes. Other programming modules that may be used in accordance with embodiments of the present disclosure may include sound encoding/decoding applications, machine learning application, acoustic classifiers, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general-purpose graphics processor-based systems, multiprocessor systems, microprocessor-based or programmable consumer electronics, application-specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer-readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include and not limited to the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Thus, an overall overview of the present invention may be described as follows: The process for creating digital currency to facilitate and collect for Road User Charges using on the distributed ledger network 200. An Entity may create an account in the Trip Exchange platform 800. Road User to connect at least one digital wallet 720 including the digital wallet used for at least one vehicle to the account in the Trip Exchange platform 800. Facility Owners to connect at least one digital wallet 725 including the digital wallet used for at least one roadway (i.e., segment) to the account in the Trip Exchange platform 800. Further, in some embodiments, entities must verify ID (e.g., distributed identity technology) using secure unique digital identifier to access account in the Trip Exchange platform 800. Further, Road User connects to Trip Exchange platform 800 to purchase digital currency (i.e., stable coin, utility tokens, etc.) using fiat currency and other digital currency which may or may not include a service fee. Further, Trip Exchange platform 800 to process an exchange of fiat currency and other digital currency to the digital wallet of the Road User for digital currency which may or may not include a service fee, stored on the DLT network 200. Further, digital currency are stored in a Road User digital wallet 720 to be used for Road User Charges (RUC), also known as Road Tax. Further, Road User to transfer Digital currency to facility owner(s) digital wallets 725 using a policy and smart contract using the DLT network 200, which may or may not include a service fee. Further, store the digital currency in a Facility Owner digital wallet 725 for collection of Road User Charges. Further, in some embodiments, entity must verify ID to access account in the Trip Exchange platform 800. Further, Facility Owner process an exchange of digital currency for fiat currency and other digital currency using the Trip Exchange Platform 800 which may or may not include a service fee.

The process for adding the digital currency to a vehicle digital wallet when at the fuel station platform 850 comprises the following steps. Road User connects to the digital wallet 720 used in at least one vehicle to the account created in the Trip Exchange platform 800. Further, Road User adds motor fuel at fueling station platform 850 to at least one vehicle. Further, Road User(s) have two options to pay motor fuel tax. First, Road User may choose to pay the motor fuel tax as part of the sale of the motor fuel (existing method). For example, petroleum-based motor fuel includes tax based on cost per gallon or liter paid at the fueling station platform 850, which excludes participation in a Road Use Charging (RUC) structure. Second, Road User purchases digital currency in place of motor fuel tax to be distributed to the facility owners for the roadways which the vehicle will use as part of a trip (present invention). For example, the digital currency will enable a Road User Charges structure based on distance of travel that will transform roadway financing. More specifically, Road User can purchase digital currency from the fuel station 850 or directly from the Trip Exchange Platform 800 by the RUC Application 870 using the Coin Manager 871 and Contract Manager 872 may use the DLT network 200.

Furthermore, Road Users may purchase the digital currency used for RUC (RUDC) from a Fuel Station platform 850 (i.e., commercial motor fuel station). Further, Fuel Station platform owner issues a policy and smart contract to the Road User with the conditions for the sale of digital currency used for RUC, posted on the distributed ledger network 200. Further, The Road User Contract Manager 872 may verify the policy and smart contract conditions. Further, upon completing the addition of motor fuel, the Coin Manager 871 calculates the estimated digital currency based on data from the RUC Database 876 which also includes but not limited to input device data and historical data from Trip Manager 878, Trip Calculator 877, and a vehicle storage device using artificial intelligence/machine learning algorithms. Further, the Contract Manager 872 uses data from the Coin Manager 871, Trip Manager 878, Trip Calculator 877 to add the required information to the Smart Contract to trigger an automated execution of the policy and Smart Contract on the distributed ledger network 200. Further, fuel station platform 850 owner transfers digital currency used for RUC (RUDC) from the Fuel Station digital wallet 725 to the Road User digital wallet 720 upon successful execution of policy and smart contract stored on the DLT network 200, to be used for Road User Charges.

Furthermore, Road Users may not have option to purchase the digital currency from a Fuel Station (i.e., home charging station). Further, upon completing the addition of motor fuel, the Coin Manager 871 calculates the estimated digital currency based on data from the RUC database 876 which also includes but not limited to input device data and historical data from Trip Manager 878 and Trip Calculator 877 the vehicle storage device using artificial intelligence/machine learning algorithms. Further, Trip Application Contract Manager 872 connects to Trip Exchange platform 800 to purchase digital currency using fiat currency and other digital currency which may or may not include a service fee. Further, Trip Exchange Platform 800 to process an exchange of fiat currency and other digital currency to the digital wallet of the Road User for digital currency which may or may not include a service fee, stored on the DLT network 200. Further, Road User receives digital currency which are stored in a Road User Digital Wallet to be used for Road User Charges.

The process for transferring digital currency from Road Users to Facility Owners for the collection of Road User Charges using the DLT network 200, comprises the following steps. Road User starts the vehicle and the RUC Application Trip Manager 878 using communication 300 and input device data 879 to determine the current location and current facility owner. Further, Road User RUC Application Trip Manager 878 starts a new segment of the trip and determines if this trip is planned or not planned. Further, Road User RUC Application Coin Manager 871 using communication devices 300 connects to the RUC rates database 876 to obtain the cost data and account/address for each facility owner. Further, Road User RUC Application Contract Manager 872 pulls the policy and smart contracts for each segment stored on the DLT network 200. Further, Road User RUC Application Contract Manager 872 provides the conditions from the policy and smart contract required data to Trip Manager 878 and Trip Calculator 872. Further, Road User RUC Application Trip Manager 878 records the position and distance data, geographic data and other data from input devices for each segment for a single trip and provide data to Trip Calculator 877. Further, Road User RUC Application Trip Calculator 872 uses input data from Trip Manager 878 and Coin Manager 871 to calculate the cost in digital currency for each segment of the trip.

More specifically, Road User RUC Application Contract Manger 872 uses the data from the Trip Calculator 877 to prepare input data in the form of conditions to the policy and the Smart Contracts between Road Users and Facility Owners. Further, The RUC Application Contract Manager 872 receives, using communication device 300, a policy and smart contract from a Facility Owner which includes the account/address and conditions for each new segment. Further, RUC Application Contract Manger 872, upon completing the segment and the trip, will compile the required data elements to meet the conditions of the policy and smart contract. Further, RUC Application Contract Manager 872 process data from the Coin Manger 871, Trip Manager 878, Trip Calculator 877 to add the required data elements or conditions, such as but not limited to distance of travel, amount of digital currency used for RUC, etc. to trigger an automated execution of the policy and smart contract on the DLT network 200. Further, Road User transfers digital currency which are stored in a Road User digital wallet 720 to be used for Road User Charges to the Facility Owner digital wallet 725 based on the policy and smart contract stored on the DLT network 200.

Embodiments of the present disclosure, for example, are described above with reference to block diagrams and operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid-state storage (e.g., USB drive), or a CD-ROM, a carrier wave from the Internet, or other forms of RAM or ROM. Further, the disclosed methods' stages may be modified in any manner, including by reordering stages and inserting or deleting stages, without departing from the disclosure.

What is claimed is:

1. A method for facilitating the collection of a Road user charge (RUC) using a digital currency based on a Distributed Ledger Technology (DLT) network implemented by a computer device including a communication device and a storage devise, the method comprising the steps of:
(A) receiving, by the computing device via the communication device, Road User digital data from at least one Road User device associated with at least one Road User unique digital identifier and Facility Owner digital data from at least one Facility Owner device associated with at least one Facility Owner unique digital identifier;
(B) processing, by the computing device via the processing device, the Road User digital data to generate at least one Road User account to store digital assets in a digital wallet, and the Facility Owner digital data to generate at least one Facility Owner account to store digital assets in a digital wallet;
(C) retrieving, by the computing device via the storage device, a digital currency to a digital wallet of the at least one Road User from at least one of a Trip Exchange platform and a fueling station platform digital wallet;
(D) analyzing, by the computing device via the processing device, Road User digital data from an RUC Application and generate a transaction of the digital currency in the form of at least one of a policy and a smart contract on the DLT network;
(E) transmitting, by the computing device via the communication device, the transaction of the digital currency in the form of the at least one of the policy and the smart contract to the at least one Road User device and the at least one Facility Owner device through the DLT network;
(F) adding, by the computing device via the processing device, the digital currency to a digital wallet of the Facility Owner account based on at least one of the policy and a smart contract and generate a transfer alert; and
(G) storing, by the computing device via the storage device, the at least one of the policy and the smart contract, a payment alert, and the transfer alert on the DLT network;
(H) receiving, by the communication device, position and distance data from at least one input device, wherein position and distance data is processed by the RUC Application;
(I) receiving, by the communication device, cost data from the at least one Facility Owner account with secure unique digital identifier associated with the at least one Facility Owner roadway from the RUC Rates Database, wherein cost data is processed by the RUC Application; and
(J) retrieving, by the storage device using minimal memory, Coin Manager data including cost data from an RUC database, Trip Manager data including digital map data, Trip Calculator data and Contract Manager data;
(K) installing the RUC Application on a vehicle platform or on a mobile device to manage the digital currency distribution, the RUC Application comprising a Coin Manager, Trip Manager, Trip Calculator, and a Contract Manager, wherein the Trip Manager having a Graphical User Interface with a digital map includes steps of:
determining, by the computing device via the processing device:
a vehicle location, a current Facility Owner,
whether a trip is planned, and
at least one segment;
recording, by the computing device via the processing device, a distance data for one or more segments;
displaying, by the computing device via the processing device, the at least one segment on the digital map;
transferring, by the computing device via the processing device, the distance data to the Trip Calculator; and
determining, by the computing device via the processing device, a first Facility Owner segment location and a second Facility Owner segment location, in response to determining the first Facility Owner segment location and the second Facility Owner segment location, if the first Facility Owner segment location and the second Facility Owner segment location is different, displaying the at least one segment on the digital map.

2. The method as claimed in claim 1 further comprising the steps of:
creating, by the computing device using a user interface that includes a screen, the Road User digital account and the Facility Owner digital account on the Trip Exchange platform;
exchanging, by one or more processors, fiat currency for the digital currency in the Trip Exchange platform by the at least one Road User digital wallet;
transferring, by one or more processors, the digital currency from the Trip Exchange platform to a digital wallet of the at least one Road User account with a secure unique digital identifier;
transmitting, by one or more processors, the digital currency from the digital wallet of the at least one Road User to the digital wallet of at least one Facility Owner account with a secure unique digital identifier and generate cryptographic message in the form of at least one of the policy and the smart contract on the DLT network;
transferring, by one or more processors, the digital currency from the digital wallet of the at least one Facility Owner account with the secure unique digital identifier to the Trip Exchange platform; and
exchanging by one or more processors, the digital currency for fiat currency and other digital currency in the Trip Exchange platform by the at least one Facility Owner digital wallet.

3. The method as claimed in claim 2 further comprising the steps of:
transmitting, by the communication device, verification of the secure unique digital identifier for the at least one Facility Owner account; and
receiving, by the communication device, verification of the identity for at least one Facility Owner account;
processing, by the communication device, the transaction of digital currency and generate a cryptographic message in the form of the payment alert based on at least one of the policy and the smart contract from the at least one Facility Owner account, on the DLT network.

4. The method as claimed in claim 1, wherein the digital currency created in the Trip Exchange platform are stored in digital wallets of the at least one Road User digital account and the at least one Facility Owner digital account.

5. The method as claimed in claim 1, wherein the Graphical User Interface is included in an on-board vehicle device.

6. The method as claimed in claim 1 further comprising the steps of:
(L) receiving, by the communication device, the payment alert based on a cryptographic message for at least one of the policy and the smart contract from the at least one Road User device on the DLT network;
(M) adding, by the processing device, the digital currency corresponding to the payment alert based on a cryptographic message to the digital wallet of the Road User on the DLT network; and
(N) transmitting, by the communication device, the transfer alert based on a cryptographic message to at least one of the at least one Road User device and the at least one Facility Owner device on the DLT network.

7. The method as claimed in claim 6 further comprising the steps of:
determining the location of a vehicle and current Facility Owner using data from one or more RUC input devices using the Trip Manager;
determining the start of a segment using the Trip Manager;
determining whether the trip is planned or not planned with a pre-selected route using the Trip Manager; and
recording position and distance data for each segment of the trip using the Trip Manager.

8. The method as claimed in claim 6 further comprising the steps of:
calculating number of the digital currency required when adding motor fuel using the Coin Manager;
connecting to the Trip Exchange platform to purchase digital currency or accept pre-paid tokens from the fueling station platform using the Coin Manager, on the DLT network; and
connecting to an RUC Rates database that maintains Facility Owner account information and the cost data for each road facility based on distance of travel, type of vehicle and other system level attributes which is set by the Facility Owner using the Coin Manager.

9. The method as claimed in claim 6 further comprising the steps of:
managing the cost for using each facility based on data from the Coin Manager and the Trip Manager using the Trip Calculator;
preparing the transactions for the Contract Manager for each segment owned by the Facility Owner using the Trip Calculator;
gathering account and address information form the Coin Manager through the RUC Rates database for each segment using the Trip Calculator; and
determining the number of digital currency based on RUC Rates database for each transaction using the Trip Calculator.

10. The method as claimed in claim 6 further comprising the steps of:
executing transaction of the digital currency, stored in the Road User digital wallet, from the Trip Calculator for each segment of a trip on the DLT network using the Contract Manager; and
logging transactions from the at least one Road User using the DLT network for auditing purposes.

11. The method as claimed in claim 6 further comprising the steps of:
gathering data form the RUC Application and the RUC input device data at an Approved Designated Location (ADL);
connecting to a RUC Rates database for RUC pricing at the ADL;
calculating number of the digital currency required by Road User for RUC at the ADL;
preparing the transactions for the Road User at the ADL;
connecting to the Trip Exchange platform to purchase the digital currency for Road Users without digital wallets; and
executing transaction of the digital currency stored in the Road User digital wallet or from the ADL using the DLT network.

12. A method for facilitating the collection of a Road user charge (RUC) using a digital currency based on a Distributed Ledger Technology (DLT) network implemented by a computer device including a communication device and a storage devise, the method comprising the steps of:
(O) receiving, by the computing device via the communication device, Road User digital data from at least one Road User device associated with at least one Road User unique digital identifier and Facility Owner digital data from at least one Facility Owner device associated with at least one Facility Owner unique digital identifier;
(P) processing, by the computing device via the processing device, the Road User digital data to generate at least one Road User account to store digital assets in a digital wallet, and the Facility Owner digital data to generate at least one Facility Owner account to store digital assets in a digital wallet;
(Q) retrieving, by the computing device via the storage device, a digital currency to a digital wallet of the at least one Road User from at least one of a Trip Exchange platform and a fueling station platform digital wallet;
(R) analyzing, by the computing device via the processing device, Road User digital data from an RUC Application and generate a transaction of the digital currency in the form of at least one of a policy and a smart contract on the DLT network;
(S) transmitting, by the computing device via the communication device, the transaction of the digital currency in the form of the at least one of the policy and the smart contract to the at least one Road User device and the at least one Facility Owner device through the DLT network;
(T) adding, by the computing device via the processing device, the digital currency to a digital wallet of the Facility Owner account based on at least one of the policy and a smart contract and generate a transfer alert;
(U) storing, by the computing device via the storage device, the at least one of the policy and the smart contract, a payment alert, and the transfer alert on the DLT network;
(V) receiving, by the communication device, position and distance data from at least one input device, wherein position and distance data is processed by the RUC Application;
(W) receiving, by the communication device, cost data from the at least one Facility Owner account with secure unique digital identifier associated with the at least one Facility Owner roadway from the RUC Rates Database, wherein cost data is processed by the RUC Application;
(X) retrieving, by the storage device using minimal memory, Coin Manager data including cost data from an RUC database, Trip Manager data including digital map data, Trip Calculator data and Contract Manager data;
(Y) installing the RUC Application on a vehicle platform or on a mobile device to manage the digital currency distribution, the RUC Application comprising a Coin Manager, Trip Manager, Trip Calculator, and a Contract Manager, wherein the Trip Manager having a Graphical User Interface with a digital map includes steps of:
determining, by the computing device via the processing device:
a vehicle location, a current Facility Owner,
whether a trip is planned, and
at least one segment;
recording, by the computing device via the processing device, a distance data for one or more segments;
displaying, by the computing device via the processing device, the at least one segment on the digital map;
displaying at least one RUC rate on the digital map;
transferring, by the computing device via the processing device, the distance data to the Trip Calculator; and
determining, by the computing device via the processing device, a first Facility Owner segment location and a second Facility Owner segment location, in response to determining the first Facility Owner segment location and the second Facility Owner segment location, if the first Facility Owner segment location and the second Facility Owner segment location is different, displaying the at least one segment on the digital map.

13. The method as claimed in claim 12, wherein the Graphical User Interface is included in an on-board vehicle device.

14. The method as claimed in claim 12 further comprising the steps of:
creating, by the computing device using a user interface that includes a screen, the Road User digital account and the Facility Owner digital account on the Trip Exchange platform;
exchanging, by one or more processors, fiat currency for the digital currency in the Trip Exchange platform by the at least one Road User digital wallet;
transferring, by one or more processors, the digital currency from the Trip Exchange platform to a digital wallet of the at least one Road User account with a secure unique digital identifier.
transmitting, by one or more processors, the digital currency from the digital wallet of the at least one Road User to the digital wallet of at least one Facility Owner account with a secure unique digital identifier and generate cryptographic message in the form of at least one of the policy and the smart contract on the DLT network;
transferring, by one or more processors, the digital currency from the digital wallet of the at least one Facility Owner account with the secure unique digital identifier to the Trip Exchange platform; and
exchanging by one or more processors, the digital currency for fiat currency and other digital currency in the Trip Exchange platform by the at least one Facility Owner digital wallet.

15. The method as claimed in claim 12 further comprising the steps of:
transmitting, by the communication device, verification of the secure unique digital identifier for the at least one Facility Owner account;
receiving, by the communication device, verification of the identity for at least one Facility Owner account;
processing, by the communication device, the transaction of digital currency and generate a cryptographic message in the form of the payment alert based on at least one of the policy and the smart contract from the at least one Facility Owner account, on the DLT network.

16. A non-transitory computer readable storage medium storing one or more programs, the one or more programs comprising instructions which, when executed by an electronic device with a display, cause the electronic device to:
(Z) receive, by the computing device via the communication device, Road User digital data from at least one Road User device associated with at least one Road User unique digital identifier and Facility Owner digital data from at least one Facility Owner device associated with at least one Facility Owner unique digital identifier;
(AA) process, by the computing device via the processing device, the Road User digital data to generate at least one Road User account to store digital assets in a digital wallet, and the Facility Owner digital data to generate at least one Facility Owner account to store digital assets in a digital wallet;
(BB) retrieve, by the computing device via the storage device, a digital currency to a digital wallet of the at least one Road User from at least one of a Trip Exchange platform and a fueling station platform digital wallet;
(CC) analyze, by the computing device via the processing device, Road User digital data from an RUC Application and generate a transaction of the digital currency in the form of at least one of a policy and a smart contract on the DLT network;
(DD) transmit, by the computing device via the communication device, the transaction of the digital currency in the form of the at least one of the policy and the smart contract to the at least one Road User device and the at least one Facility Owner device through the DLT network;
(EE) add, by the computing device via the processing device, the digital currency to a digital wallet of the Facility Owner account based on at least one of the policy and a smart contract and generate a transfer alert;
(FF) store, by the computing device via the storage device, the at least one of the policy and the smart contract, a payment alert, and the transfer alert on the DLT network;
(GG) receive, by the communication device, position and distance data from at least one input device, wherein position and distance data is processed by the RUC Application;
(HH) receive, by the communication device, cost data from the at least one Facility Owner account with secure unique digital identifier associated with the at least one Facility Owner roadway from the RUC Rates Database, wherein cost data is processed by the RUC Application;
(II) retrieve, by the storage device using minimal memory, Coin Manager data including cost data from an RUC database, Trip Manager data including digital map data, Trip Calculator data and Contract Manager data;
(JJ) install the RUC Application on a vehicle platform or on a mobile device to manage the digital currency distribution, the RUC Application comprising a Coin Manager, Trip Manager, Trip Calculator, and a Contract Manager, wherein the Trip Manager having a Graphical User Interface with a digital map includes steps of:
determining, by the computing device via the processing device:
a vehicle location, a current Facility Owner,
whether a trip is planned, and
at least one segment;
recording, by the computing device via the processing device, a distance data for one or more segments;
displaying, by the computing device via the processing device, the at least one segment on the digital map;
transferring, by the computing device via the processing device, the distance data to the Trip Calculator; and
determining, by the computing device via the processing device, a first Facility Owner segment location and a second Facility Owner segment location, in response to determining the first Facility Owner segment location and the second Facility Owner segment location, if the first Facility Owner segment location and the second Facility Owner segment location is different, displaying the at least one segment on the digital map.

17. The non-transitory computer readable storage medium as claimed in 16 storing one or more programs, the one or more programs comprising instructions which, when executed by an electronic device with a display, further cause the electronic device to:
create, by the computing device using a user interface that includes a screen, the Road User digital account and the Facility Owner digital account on the Trip Exchange platform;
exchange, by one or more processors, fiat currency for the digital currency in the Trip Exchange platform by the at least one Road User digital wallet;
transfer, by one or more processors, the digital currency from the Trip Exchange platform to a digital wallet of the at least one Road User account with a secure unique digital identifier;
transmit, by one or more processors, the digital currency from the digital wallet of the at least one Road User to the digital wallet of at least one Facility Owner account with a secure unique digital identifier and generate cryptographic message in the form of at least one of the policy and the smart contract on the DLT network;
transfer, by one or more processors, the digital currency from the digital wallet of the at least one Facility Owner account with the secure unique digital identifier to the Trip Exchange platform; and
exchange, by one or more processors, the digital currency for fiat currency and other digital currency in the Trip Exchange platform by the at least one Facility Owner digital wallet.

18. The non-transitory computer readable storage medium as claimed in 16 storing one or more programs, the one or more programs comprising instructions which, when executed by an electronic device with a display, further cause the electronic device to:
transmit, by the communication device, verification of the secure unique digital identifier for the at least one Facility Owner account;
receive, by the communication device, verification of the identity for at least one Facility Owner account;
process, by the communication device, the transaction of digital currency and generate a cryptographic message in the form of the payment alert based on at least one of the policy and the smart contract from the at least one Facility Owner account, on the DLT network.

19. The non-transitory computer readable storage medium of claim 16, wherein the Graphical User Interface is included in an on-board vehicle device.

20. The non-transitory computer readable storage medium of claim 16, wherein the digital currency created in the Trip Exchange platform are stored in digital wallets of the at least one Road User digital account and the at least one Facility Owner digital account.
